(19) United States
(12) Patent Application Publication
(10) Pub. No.: US 2009/0222292 A1
(43) Pub. Date: Sep. 3, 2009

(54) METHOD AND SYSTEM FOR MULTIPLE SUB-SYSTEMS META SECURITY POLICY

(76) Inventors: Maor Goldberg, Tel Aviv (IL); Ronny Dukat, Tel Aviv (IL); Eran Leib, Tel Aviv (IL); Shlomi Wexler, Tel Aviv (IL)

Correspondence Address: Naomi Assia Law Offices;C/O Landon IP Inc., Suite 450, 1700 Diagonal Road, Alexandria, VA, 22314, US

(21) Appl. No.: 12/038,822

(22) Filed: Feb. 28, 2008

(51) Int. Cl. G06Q 10/00

(52) U.S. Cl. 705/7

(57) ABSTRACT

A method for multiple sub-systems meta Security Policy (MSSMSP) including business process policies for a business organization having a meta policy server, Business-Asset-Monitors (BAM's) and security sub-systems, wherein the security sub-systems are supported by Policy Connectors and wherein the BAM's are software agents on each business asset that are responsible to monitor the organizational users' activities and report that information to the meta policy server. The method includes defining by a Chief-Security-Officer (CSO) of the organizational business assets, wherein the business assets are supported by the BAM's. The method also includes correlating by the CSO of abstract, business-oriented-parameters with technical, low-level parameters of the security sub-systems and validating the security policy relative to the user's by monitoring the users' activities against the business assets and by using the meta policy server, thereby enabling the creation, management and control of one central MSSMSP in correlation to the various security sub-system's policies.

### FIELD OF THE INVENTION

The present invention generally relates security management, and more particularly to a method and system for multiple sub-systems meta security policy.

### BACKGROUND OF THE INVENTION

Information Security is about taking care of the information's confidentiality, integrity and availability. Information that is valuable for the organization, when leaked, manipulated or denied access to, may cause damage to the business organization. Information today is rarely stored as physical documents and drawings in cabinets and/or safes, but is more likely stored in digital format, whether using a non-structured format, such as Microsoft Office™ files, or using a structured format, such as records inside the organization's Customers Relations Management (CRM) system.

Additionally, the digital and Internet revolutions have led to a dramatic increase in technological threats on the organization's Information-Assets, coming both from outside and inside the organization. The first Information Security “Threat” was the computer virus, which in turn led to the rise of the first Information Security system—the “Anti-Virus.” Today it is quite normal to hear, nearly every day about new security threats, quickly followed by new Information Security systems.

Recently, Information Security sub-systems have become an integral part of any enterprise organization's IT Infrastructure. In most organizations today one finds a Chief Security Officer (CSO), an Executive Director with responsibility for Information Security in the entire organization, protecting the Business Assets and assuring the Business Continuity of the organization.

The information security life cycle involves the steps of mapping and defining the business assets, analyzing the threats to these assets, implementing a security solution and testing the effectiveness of this solution. All the widely acceptable methodologies for applying and managing Information Security in enterprise organizations state that in order to achieve Information Security, one should start by creating an organizational Security Policy. This policy, usually approved by the Board of Directors, defines which and what is the valuable information in the organization, which individuals can access that information and how should this information be handled inside and outside the organization.

As opposed to the Organizational Security Policy, the Technical Security Policy derives from the security sub-systems, which operate by an essentially different policy—a specifically technical policy. The technical policy is configured by an IT expert in charge of that specific sub-system, e.g. “Networks” staff in charge of Firewalls configuration or “Windows Team” staff in charge of the directory services configuration. Technical policy for a network firewall, for example, will define which traffic may or may not pass through it, logging options, alert options, etc.

Table I is an example of a basic, simple rule-base for a network firewall:

TABLE I

| | Source | Destination | | |
|---|---|---|---|---|
| o. | Address | Address | Protocol | Action |
| | Host A - | Host B - | HTTP (80) | Permit |
| | 10.4.35.5 | 192.168.10.3 | | |
| | Host C - | Host D - | SMTP (25) | Deny |
| | 172.22.93.0 | 172.16.22.4 | | |
| | Host E - | Host F - | FTP | Permit |
| | 192.168.6.9 | 10.72.10.88 | | |
| | Any (*) | Any (*) | Any (*) | Deny |

Security products, by design, operate based on a policy which is configured by the administrator. Since Information Security products are by-design policy driven, it is common to describe access to information by the 5 “WH questions:” Who, When, Where, What and Why. Even simple and trivial security sub-systems such as Anti-Virus systems operate by a policy, specifying for instance which file-directories are being scanned, what time each day should a full-computer virus scan occur, etc.

The CSO wants a strict correlation between the organization's Executive Security Policy and the various specific sub-systems' technical policies. For example, if the Executive Security Policy states that access to the company's Enterprise Resource Planning (ERP) Finance Module is only permitted to the Chief Financial Officer (CFO) and his team, then the CSO may direct the Networking Team to configure the firewalls to allow only traffic to the appropriate server from network segments which are servicing the Finance Department.

Some of these sub-systems are not pure security systems. Microsoft's Active Directory™ is a good example, as it is not a pure security system, but it has a lot to do with securing the enterprise. Prior art FIG. 1 is a schematic illustration of how the Executive Security Policy is “passed on” and “translated” for the various IT departments and teams. Each team 110 has one or more professional agendas 120.

Thus, digital information and information systems are strategic assets to today's enterprises and can be clearly defined. The executive security policy is a document that defines the enterprise's information security policy goals and guidelines. By contrast, the actual information security policy, in each and every one of the information security sub-systems is “IT Driven” and is manually managed by the organization's IT personnel, mostly with no actual connection or linkage to the Executive Security Policy. The job of the CSO is increasingly complex, ever-persuading IT personnel to work with him in accordance with Executive Security Policy. The CSO may be the person in charge of security, but he has little control over those actually implementing it.

The growth of IT infrastructures in today's enterprise organizations has resulted in a quick, sometimes uncontrolled growth in the number of rules comprising the various technical security polices. In some enterprise organizations there are tens of thousands of security rules. For example, in a company with 5,000 employees one might find the security sub-systems shown below in Table II, where for each sub-system the number of rules per number of employees is specified.

TABLE II

| | | No. of Rules/ |
|---|---|---|
| No | Security Sub-system | No. Of Users* |
| 1 | Firewall | 10/100 |
| 2 | Endpoint Security, Anti-Virus, Anti-Spyware, | 20/500 |
| | Host-IPS, Personal FW | |
| 3 | Network IDS/IPS | 10/500 |
| 4 | Directory Services | 10/250 |
| 5 | Identity Access and/or Management System | 10/250 |
| 6 | Policy Enforcement Platform, Servers Configuration | 250/5000 |

*the number of the users is fixed, only the ratio changes.

The above company has approximately 1550 security rules, configured in its 7 different security sub-systems, by the following calculation:

Σ[10*(5000/100)]+[20*(5000/500)]+2*[10*(5000/500)]+2*[10*(5000/250)]+250 =1550

The complex IT infrastructure of today's enterprise organization's is being managed and maintained by a diverse team of IT personnel: Network experts, MS-Windows™ experts, UNIX™/Linux™ experts, MF/Legacy systems' experts, DBA's, etc. Each of them has a role in the security policy of the organization and needs to configure at least one security sub-system.

In a typical organization the Microsoft™ expert handles all the security aspects of the Active Directory™ and Anti-Virus systems, the Network Manager handles configuration of Firewalls and IPS's, while the Web-Application Firewall is configured by the Applications Development Team. As it is quite optimistic to expect these professional IT-experts to learn and understand the Executive Security Policy of the organization and act by it, so it is very optimistic to expect that the real-life, day to day configured technical security policies will actually reflect and correlate with it.

The involvement of so many manual configurations and maintenance of these thousands of Information Security rules leads to another issue—the problem of Accumulated Error.

Prior art FIG. 2 is a bar graph illustration of the accumulated error 290. The technical security sub-systems are usually configured and maintained manually by the IT personnel. Thus, some of these rules are prone to errors or miss-configurations. Errors are found in the network firewall 210, the end-point security platform 220, network IPS 230, identity management 240 and server policy enforcement 250, for example.

Automatic error scanners, tailored for security sub-systems such as Firewalls, have become popular recently, as enterprise organizations have come to the conclusion that manual configuration errors are a part of reality.

Statistics shows that these configuration errors can reach 3%-5% of any security rule-base or policy. Some software solutions offer the ability to scan and detect configuration errors in the organization's security fabric. These solutions operate by scanning the configurations, rule-bases and policies of various security sub-systems, correlating them with various external parameters, calculating and finding some of the policy miss-configurations. This indeed gives the CSO the knowledge of where there are errors, but it is done post-mortem, when the error has already been propagated into the organization's security defense lines.

There are no technologies or solutions today for managing and overcoming these errors in the policies and rule-bases of the various security sub-systems, both individually and regarding the Executive Security Policy. More than that, security configuration is designed and defined bottom-up, as the IT personnel in charge of the various security sub-systems define the security policy as they go along, often unaware of the Executive Security Policy.

Thus, it would be desirable to provide a solution to the deployment problem where the business situation has changed so much that the solution is no longer appropriate, and a gap in understanding develops during the analysis and design stages.

### SUMMARY OF THE INVENTION

Accordingly, it is a principal object of the present invention to provide a method for Multiple Sub-Systems Meta Security Policy (MSSMSP), which enables the creation, management and control of one central Security Policy which is automatically correlated with the various security sub-system's policies.

It is another principal object of the present invention to provide a new dimension of communication between the Executive Security Policy and the various security sub-system's. This dimension is the Business Asset, which is to be protected by the entire security scheme, defined by the Executive Security Policy and the Technical Security Policy.

A method is disclosed for multiple sub-systems meta Security Policy (MSSMSP) including business process policies for a business organization having a meta policy server, Business Asset Monitors (BAM's) and security sub-systems, wherein the security sub-systems are supported by Policy Connectors and wherein the BAM's are software agents on each business asset that are responsible to monitor the organizational users' activities and report that information to the meta policy server. The method includes defining by a Chief Security Officer (CSO) of the organizational business assets, wherein the business assets are supported by the BAM's. The method also includes correlating by the CSO of abstract, business oriented parameters with technical, low-level parameters of the security sub-systems and validating the security policy relative to the user's by monitoring the users' activities against the business assets and by using the meta policy server, thereby enabling the creation, management and control of one central MSSMSP in correlation to the various security sub-system's policies.

MSSMSP enables effective management of the enterprise's security policies. By understanding the logic of a business process and by monitoring its usage, one can validate that each user meets the security requirements as they exist and are managed across the IT security infrastructure. MSSSMSP uses simple positive security rules to ensure that the IT security policy meets the executive security policy. MSSMSP links the CSO and the IT's Security Sub-Systems to bring end-to-end optimal, effective security across the enterprise.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a prior art schematic illustration of how the Executive Security Policy is “passed on” and “translated” for the various IT departments and teams;

FIG. 2 is a prior art bar graph illustration of the accumulated error;

FIG. 3 is a schematic block diagram of Multiple Sub-Systems Meta Security Policy, constructed according to the principles of the present invention; and

FIG. 4 is a schematic block diagram of the Solution building blocks, constructed according to the principles of the present invention.

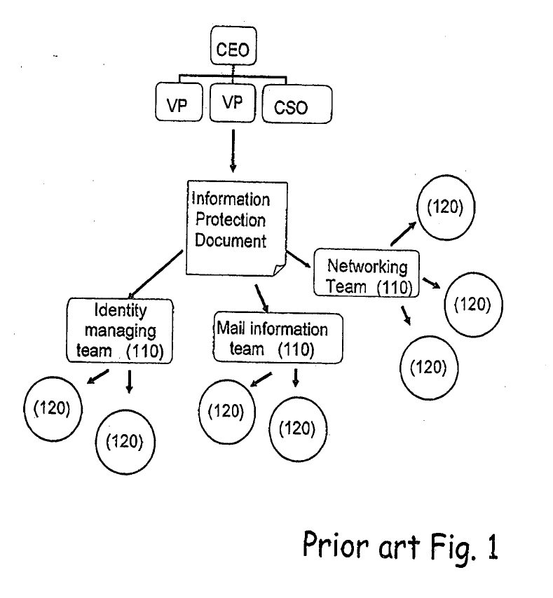

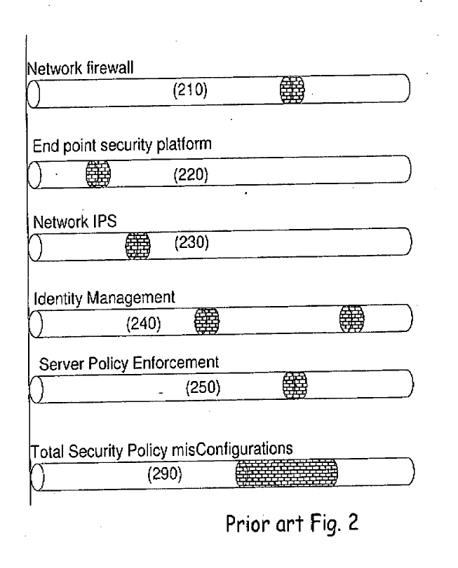

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

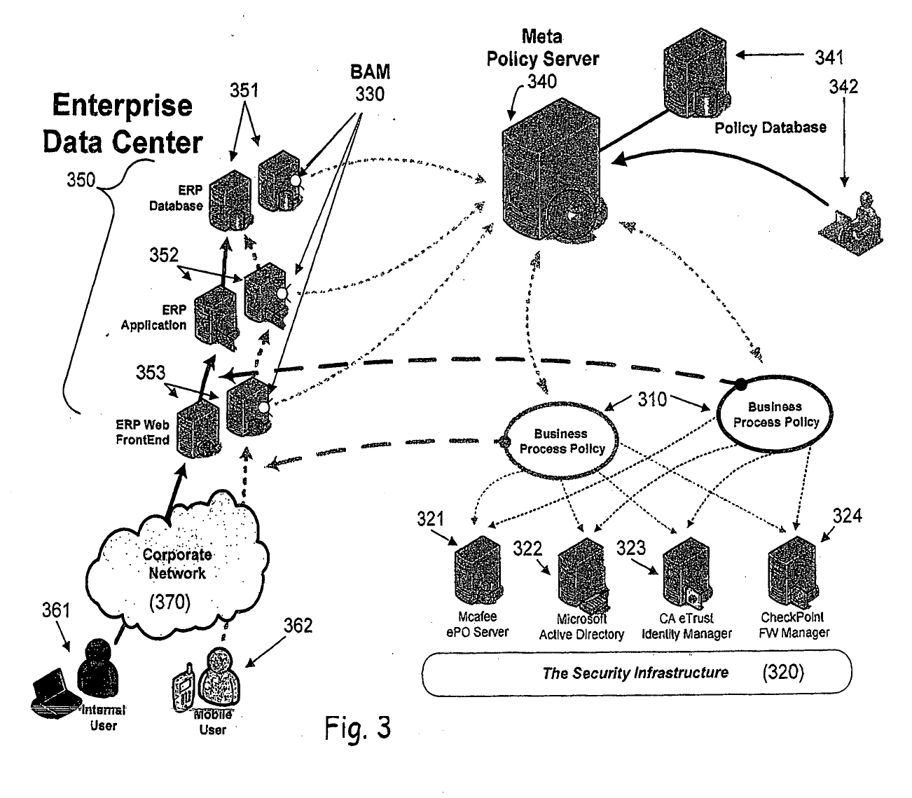

FIG. 3 is a schematic block diagram of Multiple Sub-Systems Meta Security Policy (MSSMSP), constructed according to the principles of the present invention. Using the new dimension of the business asset, one can now define a security policy for each business asset and/or process. Each of the business process policies 310 represents a specific and relevant set of rules from the various security sub-systems, as represented by the security infrastructure 320, illustrating the entire concept. The users of various business assets in the organization trigger functions which are clustered into business processes. Each business process has a single Meta Security Policy, which positively states the situations in which this process may be used. E.g., what are the conditions that must be met by the user's environment before he/she can use the business process. Security sub-systems represented by security infrastructure 320 in the exemplary organization of FIG. 3 include a McAfee ePO server 321, a MicroSoft Active Directory™ 322, a CA eTrust™ Identity Manager 323 and a CheckPoint™ FW Manager 324.

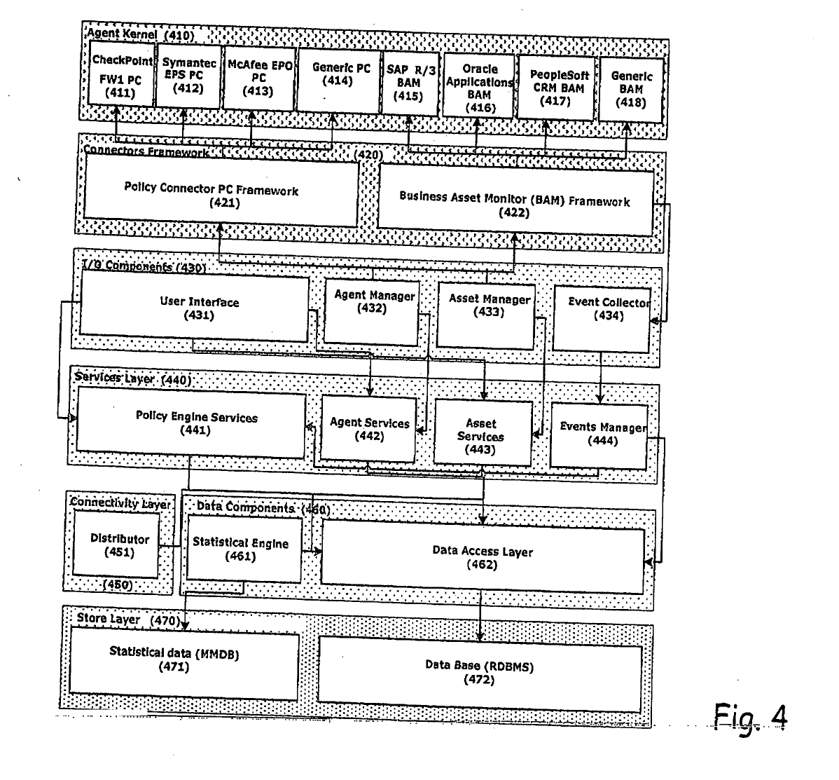

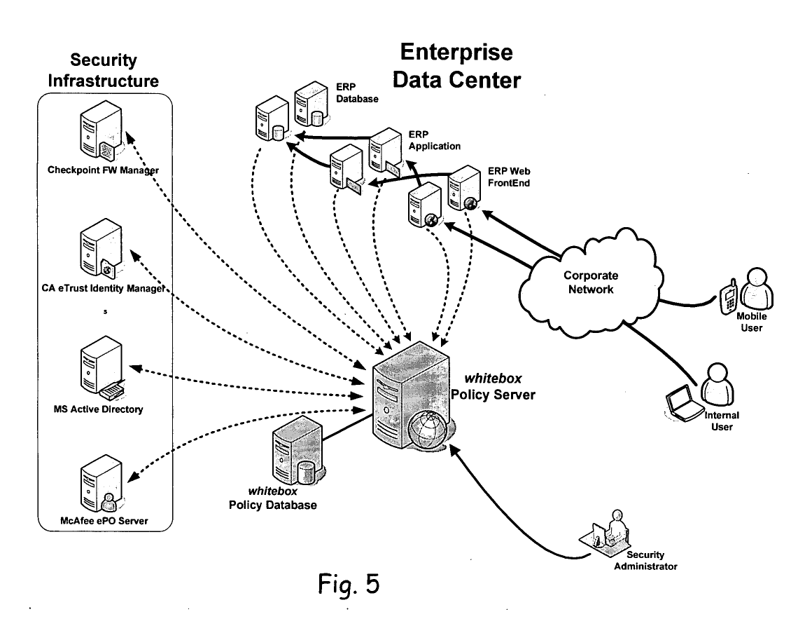

The Meta Policy Server 340 with its Meta Policy Database 341 interacts with security infrastructure 320, and is under the direction of the Security administrator 342. Meta Policy Server 340 also receives all input from the Business Assets servers in the Enterprise Data Center 350 using the Business Asset Monitor (BAM) 330. Business Assets servers include (in this example) the Enterprise Resource Planning (ERP) Database 351, the ERP Application Servers 352 and the ERP Web FrontEnd 353, and administer the business processes activated by various kind of users such as internal users 361 and mobile users 362 (in this example) via the Corporate Network Internet 370. BAM 330 is a software agent on each business asset that is responsible to monitor the user's activities and report that information to Policy Server 340. Policy server 340 will validate that the user and his environment meet the business process policy requirements. The role of BAM 330 will be described with reference to FIG. 4 below.

McAfee ePolicy Orchestrator™ 321, Active Directory™ 322, CA eTrust™ Identity Manager 323 and CheckPoint™ FW Manager 324 are all examples of Security Sub-Systems that have a technical policy which is administered by Meta Policy Server 340 using the security meta-policy.

This unified security meta-policy defines a clear, non-ambiguous security policy for each business asset, e.g. a Billing system in a Telecom Company, which will be provisioned and implemented automatically in its turn on each of the various security sub-systems.

This way the CSO will be able to easily “translate” the Executive Security Policy into technical configurations of the various security sub-systems, while eliminating the room for errors and “misunderstandings”. Security design and definition is now transformed into a top-down model, where the Executive Security Policy is the guideline and the origin of the technical policies and rule-bases defined in the various security sub-systems.

MSSMSP is responsible for translating the business oriented meta-security policy into the technical policies, rule-bases and definitions used by the various security sub-systems. This is done by linking very abstract, business oriented parameters (e.g. “Finance Dept. Users”, “Administration Dept. Floor”) with very technical, IT parameters (e.g. IP addresses, employee/user ID groups, Authorization Levels, OS versions, Peripheral Devices connection policy, etc.).

This allows the CSO to focus on creating a very simple and short set of Business Process Policies derived directory from the Executive Security Policy, stating the business oriented goals of the organization, without having to design, configure or monitor the relevant IT personnel and without having to understand the complex function of each of the security sub-systems.

FIG. 4 is a schematic block diagram of the Solution Building Blocks, constructed according to the principles of the present invention. I/O Components 430 include an Employee/User Interface 431, an Agent Manager 432, an Asset Manager 433 and an Event collector 434. The corresponding Services Layer 440 includes a Policy Engine Services 441, Agent Services 442, Asset Services 443 and an Events Manager 444.

A Connectivity Layer 450 is implemented for communicating Policy Connectors 421 and Business Asset Monitors 422 and comprises a Distributor 451. Connectivity Layer 450 coordinates with the Data Components 460, which include a Statistical Engine 461 and a Data Access Layer (DAL) 462. DAL 462 is a software library used to create, write, read and manage scientific data. Data Components 460, in turn, are coordinated with corresponding components in the Store Layer 470: Statistical Data in a Multi-Dimensional Data Base (MDDB) 471 and a Relational Data Base Management System (RDBMS) 472.

The Multiple Sub-Systems Meta Security Policy is comprised of the following building blocks:
Business Process
   Represents the business process which the employee is activating on the business asset.
   For different components of a business asset there are different BAM's which logically control the full business process.
The Business Asset Monitor (BAM) Framework 422
   These are the components designed to monitor the Business Assets as part of the Connectors Framework 420.
   These components communicate with the Meta Policy Server and reports in near real time on any business processes activated by users, with the relevant employee's information.
   Agent kernels 410 include, for example: SAP R/3™0 BAM 415, Oracle Applications™ BAM 416, PeopleSoft CRM™ BAM 417 and a generic BAM 418.
Policy Connectors (PC) Framework 421 as another part of Connectors Framework 420.
   These are the components to communicate with the various security sub-systems.
   These components communicate with the Meta Policy Server and represent the various security sub-systems. Allows central management of the sub-systems.
   Agent kernels 410 include, for example: a CheckPoint FW1™ PC 411, a Symantec EPS™ PC 412, a McAfee EpO™ PC 413 and a generic PC 414.
Meta Policy Server
   The heart of the system.
   This component allows the CSO to define his organizational business assets, while correlating abstract, business oriented parameters with very technical, low-level parameters.
This component allows definition of provisioning rules and parameters for each of the security sub-systems supported by the Policy Connectors.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for multiple sub-systems meta Security Policy (MSSMSP) comprising business process policies for a business organization having a meta policy server, Business Asset Monitors (BAM's) and security sub-systems, wherein the security sub-systems are supported by Policy Connectors and wherein the BAM's are software agents on each business asset that are responsible to monitor the organizational users' activities and report that information to the meta policy server, the method comprising:
defining by a Chief Security Officer (CSO) of the organizational business assets, wherein the business assets are supported by the BAM's;
correlating by said CSO of abstract, business oriented parameters with technical, low-level parameters of the security sub-systems; and
validating the security policy relative to the user's by monitoring the users' activities against the business assets and by using the meta policy server,
thereby enabling the creation, management and control of one central MSSMSP in correlation to the various security sub-system's policies.

2. The method of claim 1, wherein defining further comprises defining a security policy for each business asset.

3. The method of claim 1, wherein the users of various business assets in the organization trigger functions, wherein the functions are clustered into business processes.

4. The method of claim 3, wherein defining further comprises defining a security policy for each business process.

5. The method of claim 1, wherein each of the business process policies represents a specific and relevant set of rules from the various security sub-systems, as represented by a security infrastructure.

6. The method of claim 1, wherein each business process has a single Meta Security Policy, wherein the single Meta Security Policy states the situations in which this process may be used.

7. The method of claim 6, wherein said situations comprise at least the conditions that are preferably met by the user's environment before said user can use the business process.

8. A system under the direction of a chief security officer (CSO), said system providing Multiple Sub-Systems Meta Security Policy (MSSMSP) for a business organization comprising organizational business assets and employees/users, said system comprising:
a meta policy server (MPS) enabling the CSO to define the organizational business assets and to correlate abstract, business oriented parameters with technical, low-level parameters;
a plurality of business processes, wherein said business processes represent the activities the employees/user are activating on the business assets; and
a connectors framework comprising:
a business asset monitor (BAM) framework, wherein the BAM's are components designed to monitor said business assets as part of the connectors framework; and
a policy connectors (PC) framework, wherein the PC framework comprises components to communicate with the various security sub-systems,
thereby enabling the creation, management and control of one central MSSMSP in correlation to the various security sub-system's policies various security sub-system's policies.

9. The system of claim 8, wherein said MPS enables definition of provisioning rules and parameters for each of the security sub-systems supported by said PC's.

10. The system of claim 8, wherein said for different components of said business assets there are different BAM's which logically control the full business process.

11. The system of claim 8, wherein said BAM's communicate with said MPS and report in near real time on any of said plurality of business processes activated by one of said employees/users, with the corresponding employee/user's information.

12. The system of claim 8, wherein said PC framework enables central management of the sub-systems.
